(19) United States
(12) Patent Application Publication
(10) Pub. No.: US 2024/0298334 A1
(43) Pub. Date: Sep. 5, 2024

(54) CONTROL CHANNEL MONITORING

(71) Applicant: Telefonaktiebolaget LM Ericsson (publ), Stockholm (SE)

(72) Inventors: Ajit NIMBALKER, Dublin, CA (US); Ravikiran NORY, San Jose, CA (US); Ilmiawan SHUBHI, Malmö (SE); Sina MALEKI, Malmö (SE)

(21) Appl. No.: 18/261,743

(22) PCT Filed: Jan. 18, 2022
(86) PCT No.: PCT/SE2022/050054

§ 371 Date: Jul. 17, 2023

Related U.S. Application Data
(60) Provisional application No. 63/138,674, filed on Jan. 18, 2021.

(51) Int. Cl. H04W 72/232

(52) U.S. Cl. CPC H04W 72/232

(57) ABSTRACT

A method, system and apparatus are disclosed. In some embodiments, a wireless device configured to communicate with a network node is provided. The wireless device is configured to receive at least one bitfield for physical downlink control channel, PDCCH, monitoring adaptation where the at least one bitfield is configured to take at least one field value to indicate to the wireless device whether to perform one of search space set group switching and skipping of PDCCH monitoring, and configured to adapt the PDCCH monitoring for at least one cell based on the at least one field value of the at least one bitfield.

### FIELD

The present disclosure relates to wireless communications, and in particular, to modification of physical downlink control channel (PDCCH) monitoring.

### BACKGROUND

Control channel (PDCCH) monitoring is one contributing factor to wireless device power consumption in cellular systems such as system based on 3^{rd} Generation Partnership Project (3GPP) 5^{th} Generation (5G, also referred to as New Radio (NR)) wireless communication standards. Discontinuous Reception (DRX) is an important mechanism that allows reduction in wireless device power consumption by allowing the wireless device to sleep (e.g., go to DRX which may reduce/omit physical downlink control channel (PDCCH) monitoring) or to monitor PDCCH during “active time,” etc.

Active time typically includes the time duration when a DRX ON duration timer and/or a DRX Inactivity timer is running, and is a time in which the wireless device monitors PDCCH. Since packet inter-arrival time is typically an unknown quantity, to avoid unnecessary packet delays, it may be preferable to let a wireless device monitor PDCCH for a certain duration after receiving a packet (e.g., to receive a future packet), rather than allowing the wireless device to immediately go to sleep. This is achieved using the Inactivity timer (IAT) which can be set to a reasonably large value (e.g., 200 ms for a DRX cycle of length 320 ms) and allows the wireless device to be awake for a certain duration after receiving a packet. However, use of the IAT can also lead to increased power consumption especially when the IAT value is very large.

To allow the wireless device to save power during active time, several techniques have been discussed, including PDCCH search space set (SS) group switching (also referred to as search space set switching), and PDCCH skipping, which are described below.

### Search Space Set Group Switching

Two groups of search space sets for a cell can be configured in Third Generation Partnership Project (3GPP) Release (Rel)-16. If configured (through the radio resource control (RRC) parameters searchSpaceGroupIdList-r16 and searchSpaceSwitchingGroup-r16.), then the wireless device can be switched between these two groups of search space sets using either explicit or implicit mechanisms. Some search spaces may not appear in the search space sets. Such search spaces can be always and/or continuously monitored, and monitoring of such search spaces is not impacted by the search space set switching mechanism.

### Explicit SS Switching

The wireless device can be switched between the two search space set groups through detection of a DCI format 2_0. This is performed by configuring the wireless device with the RRC parameter searchSpaceSwitchTrigger-r16 which provides a location for the search space set group switching field (for a serving cell) in the DCI format 2_0. The search-space-set-switching field is one bit in size, where a bit value of zero indicates one group and a value of one indicates the second group. We refer to these two groups by group0 and group1, where the search-space-set-switching field takes the values zero and one, respectively.

The procedure for explicit switching using DCI format 2_0 is as follows:
If the wireless device is not monitoring PDCCH on search space sets corresponding to group0 and the wireless device detects DCI format 2_0, then the wireless device switches to search space sets of group0 provided that the search-space-set-switching field indicates a value of zero, and stops monitoring PDCCH on search space sets associated with group1.
If the wireless device is not monitoring PDCCH on search space sets corresponding to group1 and the wireless device detects DCI format 2_0, then the wireless device switches to search space sets of group1 provided that the search-space-set—switching field indicates a value of one. The wireless device also stops monitoring PDCCH on search space sets corresponding to group0 and starts a timer with a duration provided by the searchSpaceSwitchingTimer.
If the wireless device is monitoring PDCCH on search space sets corresponding to group1, then the wireless device switches to (or starts monitoring on) search space sets of group0 and stops monitoring on search space sets of group1 at either expiration of the searchSpaceSwitchingTimer or at the last slot of a remaining channel occupancy duration for the serving cell that is indicated by DCI format 2_0.

FIG. 1 is a diagram of an explicit search space set switching mechanism.

### Implicit SS Switching

Implicit SS switching occurs when the wireless device is not configured with the RRC searchSpaceSwitchTrigger-r16 parameter. The procedure is as follows:
if the wireless device detects a DCI format in group0, the wireless device switches to monitoring PDCCH according to SS set in group1 on the serving cell at a first slot that is at least P symbols after the slot in the active downlink (DL) bandwidth part (BWP). The wireless device sets the timer value to the value provided by searchSpaceSwitchingTimer-r16 if the wireless device detects a DCI format by monitoring PDCCH in any search space set. This applies to every subsequent detection of a DCI in any search space where if the timer is running, the wireless device restarts the timer.
if the wireless device monitors SS sets in group1, the wireless device switches to monitoring SS sets in group0 at the beginning of the first slot that is at least P symbols after a slot where the timer expires or, if the wireless device is provided with a search space set for DCI format 2_0, after a last slot of a remaining channel occupancy duration for the serving cell that is indicated by DCI format 2_0. This implies that even in the implicit case, it is still possible to enforce a set switch from group1 to group0 given that the wireless device has been configured with a search space configuration for DCI format 2_0. However, note that DCI format 2_0 is configured in the common search space and potentially affects group transitions for all wireless devices with the same SFI-RNTI decoding the DCI, i.e., the set switching is not controlled on a wireless device-basis.

FIG. 2 is a diagram of an implicit search space set switching mechanism.

A wireless device can be configured with up to 10 search space sets per cell. Cell groups are defined for SS set switching such that if SS set switching is triggered for one cell in the group of cells, it also triggers SS set switching for all cells in the corresponding group. In 3GPP Rel-16, up to four groups of cells can be supported, and these can be indicated using DCI format 2_0.

The search space set switching triggering indication can also be provided in scheduling DCI such as DCI 1-1 that schedules downlink data (e.g., PDSCH) or DCI 0-1 that can schedule uplink data (e.g., PUSCH).

### PDCCH Skipping

In PDCCH skipping, the wireless device can be configured with a bitfield within one of the scheduling DCIs to indicate a duration during which the wireless device can skip decoding of PDCCH. For example, the wireless device can be configured with a time duration of 4 ms, and when the PDCCH skipping bit within a DCI is set to 1, the wireless device can skip PDCCH monitoring for next 4 ms. Typically, the wireless device may skip PDCCH monitoring for a particular set of search spaces and RNTIs, for example, the wireless device may skip monitoring of all wireless device-specific search space sets, and/or monitoring of wireless device-specific RNTIs, such as C-RNTI, CS-RNTI, etc.

However, existing solutions for PDCCH monitoring reduction mechanisms, such as search space set group switching and PDCCH skipping, are individually applied, i.e., are applied independent of each other, where efficient methods are lacking for combining the search-space set group switching and PDCCH skipping framework for a wireless device, especially when the wireless device is configured with multiple carriers in a carrier aggregation scenario.

### SUMMARY

Some embodiments advantageously provide methods, systems, and apparatuses for modification of physical downlink control channel (PDCCH) monitoring.

A method of joint L1 indication of search space set switching and PDCCH skipping is described herein. Also described herein is a method of efficient control of the PDCCH monitoring adaption or adaptation when the wireless device is configured with carrier aggregation, as well as for cases when the wireless device is configured with dormant BWP for some SCells and search space set switching for some SCells.

According to one aspect of the present disclosure, a wireless device configured to communicate with a network node is provided. The wireless device is configured to receive at least one bitfield for physical downlink control channel, PDCCH, monitoring adaptation where the at least one bitfield is configured to take at least one field value to indicate to the wireless device whether to perform one of: search space set group switching and skipping of PDCCH monitoring. The wireless device is further configured to adapt the PDCCH monitoring for at least one cell based on the at least one field value of the at least one bitfield.

According to one or more embodiments of this aspect, the wireless device is configured with at least two search space set groups for the at least one cell and where the search space set group switching corresponds to switching among the at least two search space set groups for the at least one cell. According to one or more embodiments of this aspect, the wireless device is configured with a skip duration for the at least one cell and where the skipping of PDCCH monitoring corresponds to skipping of PDCCH monitoring for the at least one cell according to the skip duration. According to one or more embodiments of this aspect, the at least one bitfield is configurable to: take only field values that indicate to the wireless device to perform search space set group switching or take only field values that indicate to the wireless device to perform skipping of PDCCH monitoring or take field values that indicate to the wireless device to perform search space set group switching as well as field values that indicate to the wireless device to perform skipping of PDCCH monitoring.

According to one or more embodiments of this aspect, the at least one bitfield is configured to take one or more of at least two field values that indicate the search space set group switching and one or more field values that indicate the skipping of PDCCH monitoring. According to one or more embodiments of this aspect, the at least one field value includes one or more of: a first field value indicating to perform PDCCH monitoring according to a first search space set group, a second field value indicating to perform PDCCH monitoring according to a second search space set group, and a third field value indicating to skip PDCCH monitoring according to a skip duration. According to one or more embodiments of this aspect, the at least one cell includes a first serving cell of the wireless device and the at least one bitfield includes a bitfield for PDCCH monitoring adaptation for the first serving cell and where the wireless device is configured to receive the bitfield for PDCCH monitoring adaptation for the first serving cell in the first serving cell.

According to one or more embodiments of this aspect, the at least one cell includes a group of cells and the at least one bitfield includes a bitfield for PDCCH monitoring adaptation for the group of cells and where the wireless device (22) is configured to receive the bitfield for PDCCH monitoring adaptation for the group of cells in only a first cell of the group of cells. According to one or more embodiments of this aspect, the first cell of the group of cells is one of a primary cell and a secondary cell of the wireless device. According to one or more embodiments of this aspect, the at least one cell includes a first group of cells and a second group of cells and where the at least one field value of the at least one bitfield includes a field value of a first bitfield associated with the first group of cells and a field value of a second bitfield associated with the second group of cells and where the wireless device is configured to adapt PDCCH monitoring for the first group of cells based on the field value of the first bitfield, and to adapt PDCCH monitoring for the second group of cells based on the field value of the second bitfield. According to one or more embodiments of this aspect, the wireless device is configured to receive the second bitfield for the PDCCH monitoring adaptation for the second group of cells in at least one cell of the first group of cells only.

According to one or more embodiments of this aspect, the at least one cell includes a second cell that is not configured with a dormant bandwidth part, BWP, and where the at least one bitfield includes at least one secondary cell, SCell, dormancy bit that indicates to the wireless device whether to perform one of search space set group switching and skipping of PDCCH monitoring for the second cell. According to one or more embodiments of this aspect, the at least one bitfield is received in a downlink control information, DCI, format, and where the DCI format is one of DCI formats 0-1, 1-1, 1-2 and 0-2.

According to another aspect of the present disclosure, a network node configured to communicate with a wireless device is provided. The network node is configured to configure the wireless device with at least one bitfield for physical downlink control channel, PDCCH, monitoring adaptation where the at least one bitfield is configured to take at least one field value to indicate to the wireless device whether to perform one of search space set group switching and skipping of PDCCH monitoring. The network node is further configured to cause transmission of the at least one bitfield to the wireless device to adapt the PDCCH monitoring for at least one cell at the wireless device based on the at least one field value of the at least one bitfield.

According to one or more embodiments of this aspect, the network node is further configured to configure the wireless device with at least two search space set groups for the at least one cell and where the search space set group switching corresponds to switching among the at least two search space set groups for the at least one cell. According to one or more embodiments of this aspect, the network node is further configured to configure the wireless device with a skip duration for the at least one cell and wherein the skipping of PDCCH monitoring corresponds to skipping of PDCCH monitoring for the at least one cell according to the skip duration. According to one or more embodiments of this aspect, the at least one bitfield is configurable to take only field values that indicate to the wireless device to perform search space set group switching or take only field values that indicate to the wireless device to perform skipping of PDCCH monitoring or take field values that indicate to the wireless device to perform search space set group switching as well as field values that indicate to the wireless device to perform skipping of PDCCH monitoring.

According to one or more embodiments of this aspect, the at least one bitfield is configured to take one or more of at least two field values that indicate the search space set group switching, and one or more field values that indicate the skipping of PDCCH monitoring. According to one or more embodiments of this aspect, the at least one field value includes one or more of a first field value indicating to perform PDCCH monitoring according to a first search space set group, a second field value indicating to perform PDCCH monitoring according to a second search space set group, and a third field value indicating to skip PDCCH monitoring according to a skip duration. According to one or more embodiments of this aspect, the at least one cell includes a first serving cell of the wireless device and the at least one bitfield includes a bitfield for PDCCH monitoring adaptation for the first serving cell and where the network node is configured to cause the transmission to the wireless device includes the network node being configured to cause transmission of the bitfield for PDCCH monitoring adaptation for the first serving cell to the wireless device in the first serving cell.

According to one or more embodiments of this aspect, the at least one cell includes a group of cells and the at least one bitfield includes a bitfield for PDCCH monitoring adaptation for the group of cells and where the network node being configured to cause the transmission to the wireless device includes the network node being configured to cause transmission of the bitfield for PDCCH monitoring adaptation for the group of cells to the wireless device in only a first cell of the group of cells. According to one or more embodiments of this aspect, the first cell of the group of cells is one of a primary cell and a secondary cell of the wireless device. According to one or more embodiments of this aspect, the at least one cell includes a first group of cells and a second group of cells and where the at least one field value of the at least one bitfield includes a field value of a first bitfield associated with the first group of cells and a field value of a second bitfield associated with the second group of cells and where the network node being configured to cause the transmission to the wireless device includes the network node being configured to cause transmission of the first bitfield to the wireless device to adapt the PDCCH monitoring for the first group of cells based on the field value of the first bitfield, and to cause transmission of the second bitfield to the wireless device to adapt PDCCH monitoring for the second group of cells based on the field value of the second bitfield. According to one or more embodiments of this aspect, the network node is configured to cause the transmission of the second bitfield for the PDCCH monitoring adaptation for the second group of cells to the wireless device in at least one cell of the first group of cells only.

According to one or more embodiments of this aspect, the at least one cell includes a second cell that is not configured with a dormant bandwidth part, BWP, and wherein the at least one bitfield includes at least one secondary cell, SCell, dormancy bit that indicates to the wireless device whether to perform one of search space set group switching and skipping of PDCCH monitoring for the second cell. According to one or more embodiments of this aspect, the first bitfield is transmitted in a downlink control information, DCI, format, and where the DCI format is one of DCI formats 0-1, 1-1, 1-2 and 0-2.

According to another aspect of the present disclosure, a method implemented by a wireless device that is configured to communicate with a network node is provided. At least one bitfield for physical downlink control channel, PDCCH, monitoring adaptation is received where the at least one bitfield is configured to take at least one field value to indicate to the wireless device whether to perform one of search space set group switching and skipping of PDCCH monitoring. The PDCCH monitoring is adapted for at least one cell based on the at least one field value of the at least one bitfield.

According to one or more embodiments of this aspect, the wireless device is configured with at least two search space set groups for the at least one cell and where the search space set group switching corresponds to switching among the at least two search space set groups for the at least one cell. According to one or more embodiments of this aspect, the wireless device is configured with a skip duration for the at least one cell and wherein the skipping of PDCCH monitoring corresponds to skipping of PDCCH monitoring for the at least one cell according to the skip duration. According to one or more embodiments of this aspect, the at least one bitfield is configurable to: take only field values that indicate to the wireless device to perform search space set group switching, or take only field values that indicate to the wireless device to perform skipping of PDCCH monitoring, or take field values that indicate to the wireless device to perform search space set group switching as well as field values that indicate to the wireless device to perform skipping of PDCCH monitoring.

According to one or more embodiments of this aspect, the at least one bitfield is configured to take one or more of at least two field values that indicate the search space set group switching, and one or more field values that indicate the skipping of PDCCH monitoring. According to one or more embodiments of this aspect, the at least one field value includes one or more of a first field value indicating to perform PDCCH monitoring according to a first search space set group, a second field value indicating to perform PDCCH monitoring according to a second search space set group, and a third field value indicating to skip PDCCH monitoring according to a skip duration. According to one or more embodiments of this aspect, the at least one cell includes a first serving cell of the wireless device and the at least one bitfield includes a bitfield for PDCCH monitoring adaptation for the first serving cell and where the wireless device receives the bitfield for PDCCH monitoring adaptation for the first serving cell in the first serving cell.

According to one or more embodiments of this aspect, the at least one cell includes a group of cells and the at least one bitfield includes a bitfield for PDCCH monitoring adaptation for the group of cells and where the wireless device receives the bitfield for PDCCH monitoring adaptation for the group of cells in only a first cell of the group of cells. According to one or more embodiments of this aspect, the first cell of the group of cells is one of a primary cell and a secondary cell of the wireless device. According to one or more embodiments of this aspect, the at least one cell includes a first group of cells and a second group of cells and where the at least one field value of the at least one bitfield includes a field value of a first bitfield associated with the first group of cells and a field value of a second bitfield associated with the second group of cells and where the wireless device adapts PDCCH monitoring for the first group of cells based on the field value of the first bitfield, and adapts PDCCH monitoring for the second group of cells based on the field value of the second bitfield. According to one or more embodiments of this aspect, the wireless device receives the second bitfield for the PDCCH monitoring adaptation for the second group of cells in at least one cell of the first group of cells only.

According to one or more embodiments of this aspect, the at least one cell includes a second cell that is not configured with a dormant bandwidth part, BWP; and where the at least one bitfield includes at least one secondary cell, SCell, dormancy bit that indicates to the wireless device whether to perform one of search space set group switching and skipping of PDCCH monitoring for the second cell. According to one or more embodiments of this aspect, the wireless device receives the at least one bitfield in a downlink control information, DCI, format, and where the DCI format is one of DCI formats 0-1, 1-1, 1-2 and 0-2.

According to another aspect of the present disclosure, a method implemented by a network node that is configured to communicate with a wireless device is provided. The wireless device is configured with at least one bitfield for physical downlink control channel, PDCCH, monitoring adaptation where the at least one bitfield is configured to take at least one field value to indicate to the wireless device whether to perform one of search space set group switching, and skipping of PDCCH monitoring. Transmission of the at least one bitfield is caused to the wireless device to adapt the PDCCH monitoring for at least one cell at the wireless device based on the at least one field value of the at least one bitfield.

According to one or more embodiments of this aspect, the wireless device is configured with at least two search space set groups for the at least one cell and where the search space set group switching corresponds to switching among the at least two search space set groups for the at least one cell. According to one or more embodiments of this aspect, the wireless device is configured with a skip duration for the at least one cell and where the skipping of PDCCH monitoring corresponds to skipping of PDCCH monitoring for the at least one cell according to the skip duration. According to one or more embodiments of this aspect, the at least one bitfield is configurable to take only field values that indicate to the wireless device to perform search space set group switching, or take only field values that indicate to the wireless device to perform skipping of PDCCH monitoring, or take field values that indicate to the wireless device to perform search space set group switching as well as field values that indicate to the wireless device to perform skipping of PDCCH monitoring.

According to one or more embodiments of this aspect, the at least one bitfield is configured to take one or more of: at least two field values that indicate the search space set group switching, and one or more field values that indicate the skipping of PDCCH monitoring. According to one or more embodiments of this aspect, the at least one field value includes one or more of: a first field value indicating to perform PDCCH monitoring according to a first search space set group, a second field value indicating to perform PDCCH monitoring according to a second search space set group, and a third field value indicating to skip PDCCH monitoring according to a skip duration. According to one or more embodiments of this aspect, the at least one cell includes a first serving cell of the wireless device and the at least one bitfield includes a bitfield for PDCCH monitoring adaptation for the first serving cell and where the network node causing the transmission to the wireless device includes the network node causing transmission of the bitfield for PDCCH monitoring adaptation for the first serving cell to the wireless device in the first serving cell.

According to one or more embodiments of this aspect, the at least one cell includes a group of cells and the at least one bitfield includes a bitfield for PDCCH monitoring adaptation for the group of cells and where the network node causing the transmission to the wireless device includes the network node causing transmission of the bitfield for PDCCH monitoring adaptation for the group of cells to the wireless device in only a first cell of the group of cells. According to one or more embodiments of this aspect, the first cell of the group of cells is one of a primary cell and a secondary cell of the wireless device. According to one or more embodiments of this aspect, the at least one cell includes a first group of cells and a second group of cells and where the at least one field value of the at least one bitfield includes a field value of a first bitfield associated with the first group of cells and a field value of a second bitfield associated with the second group of cells and where the network node causing the transmission to the wireless device includes the network node causing transmission of the first bitfield to the wireless device to adapt the PDCCH monitoring for the first group of cells based on the field value of the first bitfield, and causing transmission of the second bitfield to the wireless device to adapt PDCCH monitoring for the second group of cells based on the field value of the second bitfield. According to one or more embodiments of this aspect, the network node causes the transmission of the second bitfield for the PDCCH monitoring adaptation for the second group of cells to the wireless device in at least one cell of the first group of cells only.

According to one or more embodiments of this aspect, the at least one cell includes a second cell that is not configured with a dormant bandwidth part, BWP, and where the at least one bitfield includes at least one secondary cell, SCell, dormancy bit that indicates to the wireless device whether to perform one of search space set group switching and skipping of PDCCH monitoring for the second cell. According to one or more embodiments of this aspect, the network node causes the transmission of the at least one bitfield in a downlink control information, DCI, format, where the DCI format is one of DCI formats 0-1, 1-1, 1-2 and 0-2.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of an explicit search space set switching mechanism;

FIG. 2 is a diagram of an implicit search space set switching mechanism;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node according to some embodiments of the present disclosure;

FIG. 10 is a flowchart of another example process in a network node according to some embodiments of the present disclosure;

FIG. 11 is a flowchart of an example process in a wireless device according to some embodiments of the present disclosure;

FIG. 12 is a flowchart of another example process in a wireless device according to some embodiments of the present disclosure;

FIG. 13 is a diagram of different bitfields configured in a DCI to control PDCCH monitoring adaptation for different cell groups; and

FIG. 14 is a diagram of different bitfields configured in a DCI to control PDCCH monitoring adaptation for different cell groups and also CG indication bitfield.

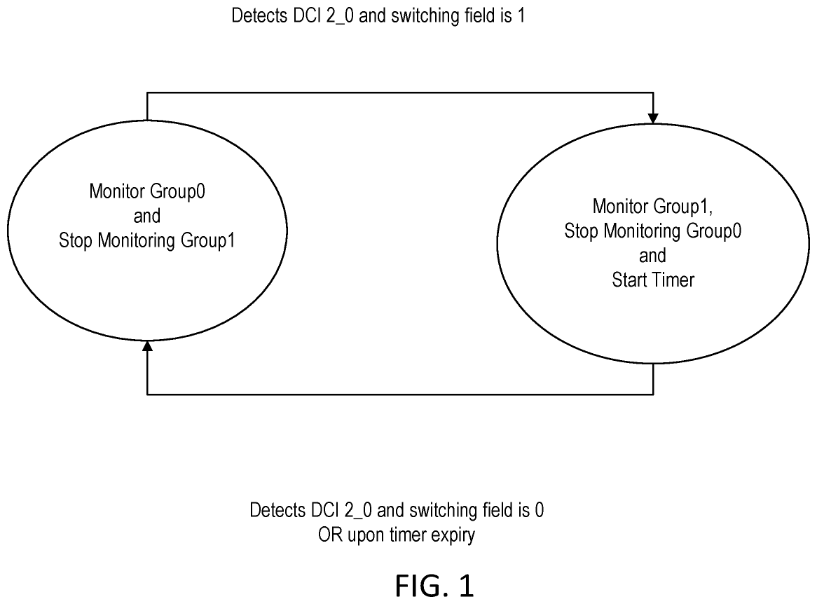

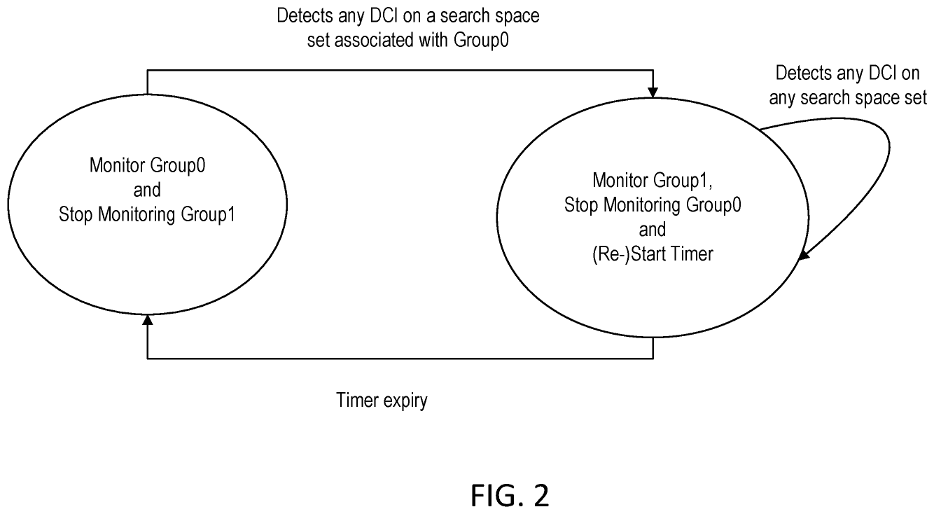

### DETAILED DESCRIPTION

As described above, existing systems lack methods to efficiently combine the search-space set group switching and PDCCH skipping framework for a given wireless device, especially when the wireless device is configured multiple carriers in a carrier aggregation scenario. The present disclosure advantageously solves at least a portion of the problems with existing systems by providing methods and mechanisms to provide the wireless device with the opportunity to reduce PDCCH monitoring during active time of C-DRX using both search-space set group switching and

PDCCH skipping mechanisms, thereby achieving power savings. One or more embodiments described herein also reduce the PDCCH resources at the network node side e.g., by allowing the network node to indicate PDCCH monitoring adaptions for a group of cells in an efficient manner. Furthermore, one or more embodiments described herein provide the network node with the flexibility to choose flexibly between search space set group switching or PDCCH skipping depending on the traffic situation, data arrival patterns, latency, etc.

Before describing in detail example embodiments, it is noted that the embodiments reside primarily in combinations of apparatus components and processing steps related to modification of PDCCH monitoring. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3^{rd} party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipment (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

A cell may be generally a communication cell, e.g., of a cellular or mobile communication network, provided by a node. A serving cell may be a cell on or via which a network node (the node providing or associated to the cell, e.g., base station, gNB or eNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE-standard. One or more carriers (e.g., uplink and/or downlink carrier/s and/or a carrier for both uplink and downlink) may be associated to a cell.

Transmitting in downlink may pertain to transmission from the network or network node to the wireless device. Transmitting in uplink may pertain to transmission from the wireless device to the network or network node. Transmitting in sidelink may pertain to (direct) transmission from one wireless device to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Configuring a terminal or wireless device or node may involve instructing and/or causing the wireless device or node to change its configuration, e.g., PDCCH monitoring configuration. A terminal or wireless device or node may be adapted to configure itself, e.g., according to information or data in a memory of the terminal or wireless device. Configuring a node or terminal or wireless device by another device or node or a network may refer to and/or comprise transmitting information and/or data and/or instructions to the wireless device or node by the other device or node or the network such as via a bitfield described herein. Configuring a terminal may include sending configuration data to the terminal indicating which modulation and/or encoding to use.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

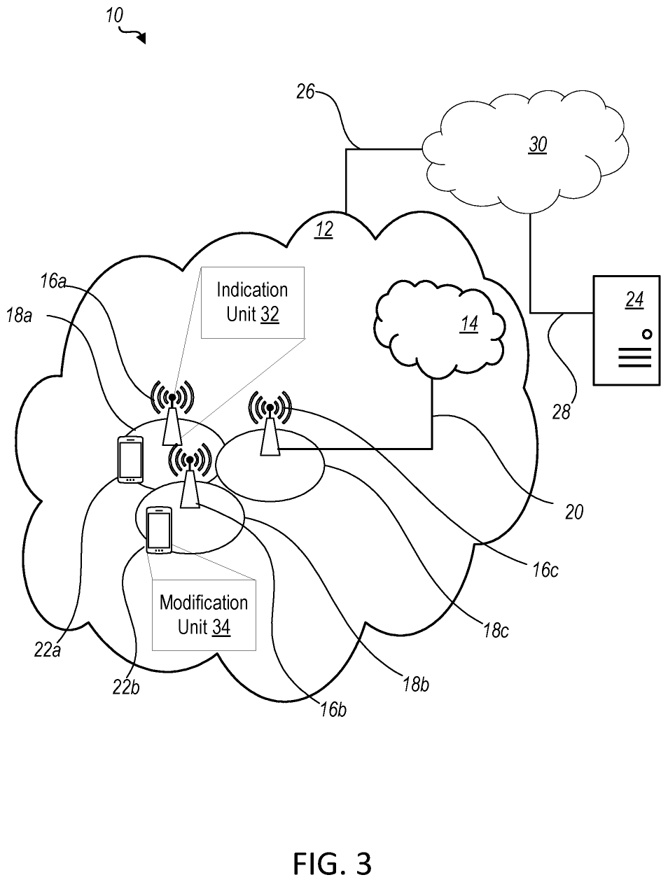

Some embodiments provide modification of PDCCH monitoring. Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an indication unit 32 which is configured to perform one or more network node 16 functions described herein such as with respect to modification of PDCCH monitoring. A wireless device 22 is configured to include a modification unit 34 which is configured to perform one or more wireless device 22 functions as described herein such as with respect to modification of PDCCH monitoring.

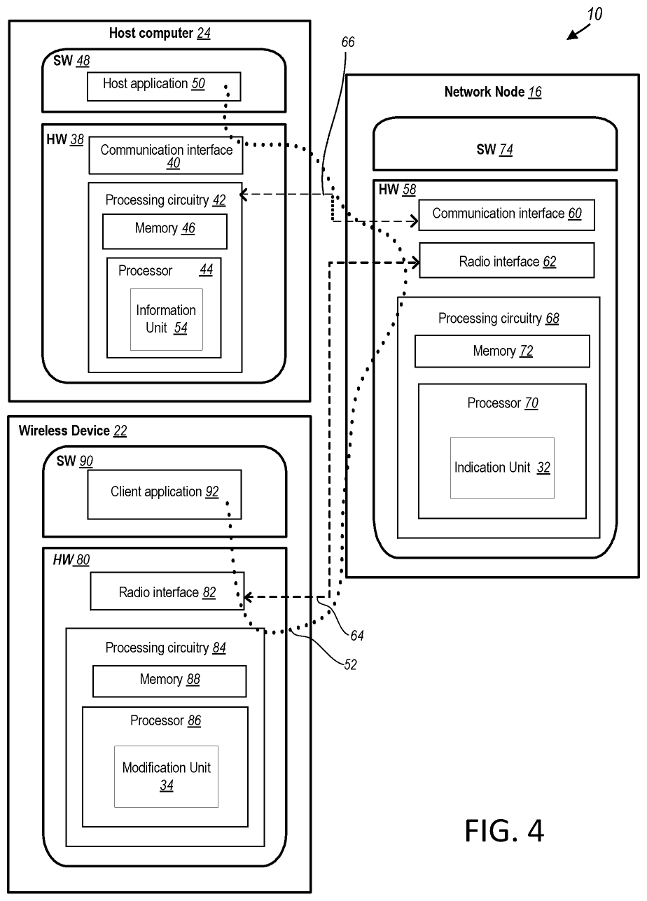

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of process, store, forward, relay, transmit, receive, analyze, etc., information related to modification of PDCCH monitoring.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include indication unit 32 configured to perform one or more network node 16 functions as described herein such as with respect to modification of PDCCH monitoring.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a modification unit 34 configured to perform one or more wireless device 22 functions as described herein such as with respect to modification of PDCCH monitoring.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending receipt of a transmission from the WD 22.

In some embodiments, the host computer 24 includes processing circuitry 42 and a communication interface 40 that is configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending receipt of a transmission from the network node 16.

Although FIGS. 3 and 4 show various “units” such as indication unit 32, and modification unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

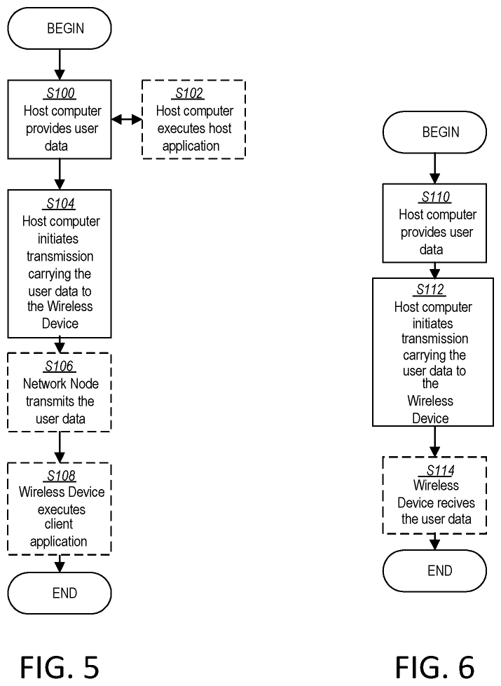

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

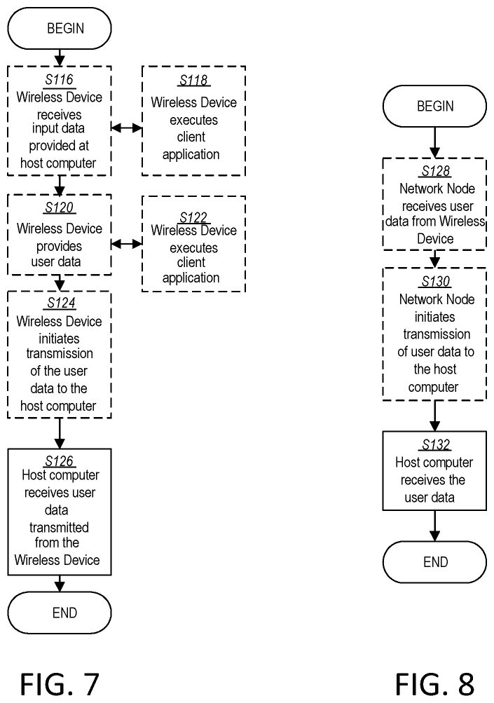

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

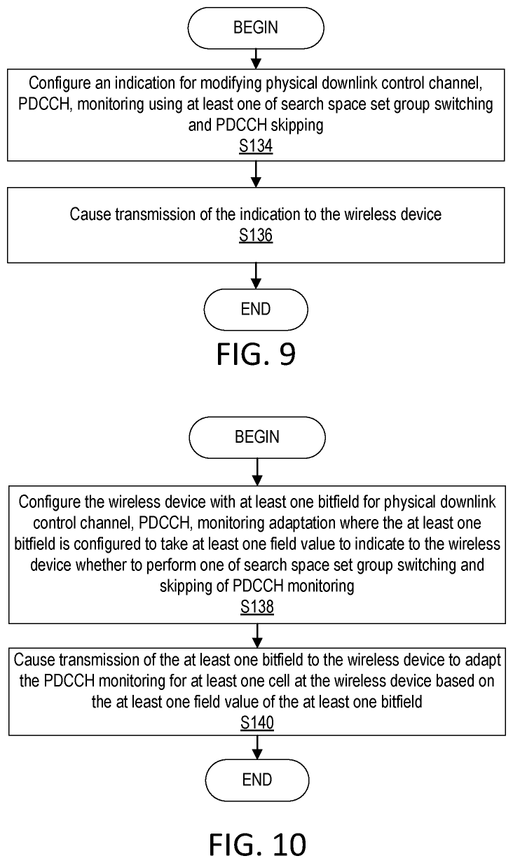

FIG. 9 is a flowchart of an example process in a network node 16 according to some embodiments of the present disclosure. One or more Blocks and/or functions performed by network node 16 may be performed by one or more elements of network node 16 such as by indication unit 32 in processing circuitry 68, processor 70, radio interface 62, etc. In one or more embodiments, network node 16 is configured to configure (Block S134) an indication for modifying physical downlink control channel, PDCCH, monitoring using at least one of search space set group switching and PDCCH skipping, as described herein. In one or more embodiments, network node 16 is configured to cause transmission (Block S136) of the indication to the wireless device 22, as described herein.

According to one or more embodiments, the indication is a bitfield that indicates performing both the search space set group switching and PDCCH skipping. According to one or more embodiments, the bitfield is configured to control at least one of search space set group switching and PDCCH skipping for at least one group of cells. According to one or more embodiments, the bitfield is configured to control at least one of search space set group switching and PDCCH skipping for a first group of cells and separately for a second group of cells. According to one or more embodiments, the bitfield is one of a PDCCH monitoring adaptation bitfield and cell group indication bitfield.

Further, as used herein in one or more embodiments, the at least one bitfield (e.g., PDCCH monitoring adaptation bitfield) takes one field value at a time. This means that while the at least one bitfield is configurable to take field values that indicate to the wireless device to perform search space set group switching and field values that indicate to the wireless device to perform skipping of PDCCH monitoring, these field values do not indicate to the wireless device to simultaneously perform search space set group switching and skipping of PDCCH monitoring.

FIG. 10 is a flowchart of another example process in a network node 16 according to some embodiments of the present disclosure. One or more Blocks and/or functions performed by network node 16 may be performed by one or more elements of network node 16 such as by indication unit 32 in processing circuitry 68, processor 70, radio interface 62, etc. In one or more embodiments, network node 16 is configured to configure (Block S138) the wireless device 22 with at least one bitfield for physical downlink control channel, PDCCH, monitoring adaptation where the at least one bitfield is configured to take at least one field value to indicate to the wireless device 22 whether to perform one of search space set group switching and skipping of PDCCH monitoring, as described herein. In one or more embodiments, network node 16 is configured to cause (Block S140) transmission of the at least one bitfield to the wireless device 22 to adapt the PDCCH monitoring for at least one cell 18 at the wireless device 22 based on the at least one field value of the at least one bitfield, as described herein.

According to one or more embodiments, the network node 16 is further configured to configure the wireless device 22 with at least two search space set groups for the at least one cell 18 and wherein the search space set group switching corresponds to switching among the at least two search space set groups for the at least one cell 18. According to one or more embodiments the network node 16 is further configured to configure the wireless device 22 with a skip duration for the at least one cell 18 and where the skipping of PDCCH monitoring corresponds to skipping of PDCCH monitoring for the at least one cell 18 according to the skip duration. According to one or more embodiments, the at least one bitfield is configurable to: take only field values that indicate to the wireless device 22 to perform search space set group switching, or take only field values that indicate to the wireless device 22 to perform skipping of PDCCH monitoring, or take field values that indicate to the wireless device 22 to perform search space set group switching as well as field values that indicate to the wireless device 22 to perform skipping of PDCCH monitoring.

According to one or more embodiments, the at least one bitfield is configured to take one or more of at least two field values that indicate the search space set group switching, and one or more field values that indicate the skipping of PDCCH monitoring. The one or more field values may for example be at least one field value that indicates the skipping of PDCCH monitoring.

According to one or more embodiments, the at least one field value includes one or more of: a first field value indicating to perform PDCCH monitoring according to a first search space set group, a second field value indicating to perform PDCCH monitoring according to a second search space set group, and a third field value indicating to skip PDCCH monitoring according to a skip duration. According to one or more embodiments, the at least one cell 18 includes a first serving cell 18 of the wireless device 22 and the at least one bitfield includes a bitfield for PDCCH monitoring adaptation for the first serving cell 18 and where the network node 16 is configured to cause the transmission to the wireless device 22 includes the network node 16 being configured to cause transmission of the bitfield for PDCCH monitoring adaptation for the first serving cell 18 to the wireless device 22 in the first serving cell 18.

According to one or more embodiments, the at least one cell 18 includes a group of cells 18 and the at least one bitfield includes a bitfield for PDCCH monitoring adaptation for the group of cells 18 and where the network node 16 is configured to cause the transmission to the wireless device 22 includes the network node 16 being configured to cause transmission of the bitfield for PDCCH monitoring adaptation for the group of cells 18 to the wireless device 22 in only a first cell of the group of cells 18. According to one or more embodiments, the first cell 18 of the group of cells 18 is one of a primary cell and a secondary cell of the wireless device 22. According to one or more embodiments, the at least one cell includes a first group of cells 18 and a second group of cells 18 and wherein the at least one field value of the at least one bitfield includes a field value of a first bitfield associated with the first group of cells 18 and a field value of a second bitfield associated with the second group of cells 18 and where the network node 16 is configured to cause the transmission to the wireless device 22 includes the network node 16 being configured to cause transmission of the first bitfield to the wireless device 22 to adapt the PDCCH monitoring for the first group of cells 18 based on the field value of the first bitfield, and to cause transmission of the second bitfield to the wireless device 22 to adapt PDCCH monitoring for the second group of cells 18 based on the field value of the second bitfield. The first group of cells may in some examples be different from the second group of cells, e.g. in that at least one, or some, or all, cells included in the first group are different from the cells included in the second group of cells.

According to one or more embodiments, the network node 16 is configured to cause the transmission of the second bitfield for the PDCCH monitoring adaptation for the second group of cells 18 to the wireless device 22 in at least one cell of the first group of cells 18 only. According to one or more embodiments, the at least one cell includes a second cell 18 that is not configured with a dormant bandwidth part, BWP, and where the at least one bitfield includes at least one secondary cell, SCell, dormancy bit that indicates to the wireless device 22 whether to perform one of search space set group switching and skipping of PDCCH monitoring for the second cell. According to one or more embodiments, the first bitfield is transmitted in a downlink control information, DCI, format, and where the DCI format is one of DCI formats 0-1, 1-1, 1-2 and 0-2.

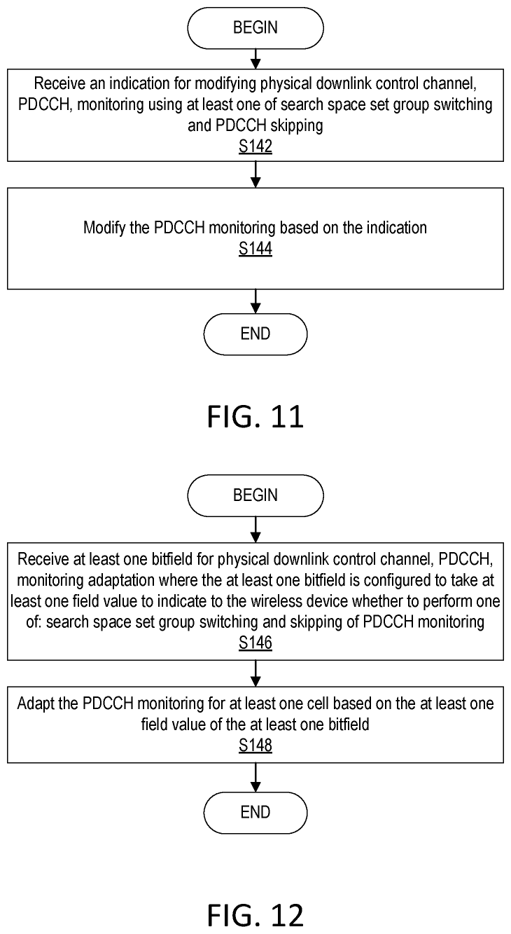

FIG. 11 is a flowchart of an example process in a wireless device 22 according to some embodiments of the present disclosure. One or more Blocks and/or functions performed by wireless device 22 may be performed by one or more elements of wireless device 22 such as by modification unit 34 in processing circuitry 84, processor 86, radio interface 82, etc. In one or more embodiments, wireless device is configured to receive (Block S142) an indication for modifying physical downlink control channel, PDCCH, monitoring using at least one of search space set group switching and PDCCH skipping, as described herein. In one or more embodiments, wireless device is configured to modify (Block S144) the PDCCH monitoring based on the indication, as described herein.

According to one or more embodiments, the indication is a bitfield that indicates performing both the search space set group switching and PDCCH skipping. According to one or more embodiments, the bitfield is configured to control at least one of search space set group switching and PDCCH skipping for at least one group of cells. According to one or more embodiments, the bitfield is configured to control at least one of search space set group switching and PDCCH skipping for a first group of cells and separately for a second group of cells. According to one or more embodiments, the bitfield is one of a PDCCH monitoring adaptation bitfield and cell group indication bitfield.

FIG. 12 is a flowchart of another example process in a wireless device 22 according to some embodiments of the present disclosure. One or more Blocks and/or functions performed by wireless device 22 may be performed by one or more elements of wireless device 22 such as by modification unit 34 in processing circuitry 84, processor 86, radio interface 82, etc. In one or more embodiments, wireless device is configured to receive (Block S146) at least one bitfield for physical downlink control channel, PDCCH, monitoring adaptation where the at least one bitfield is configured to take at least one field value to indicate to the wireless device 22 whether to perform one of: search space set group switching and skipping of PDCCH monitoring, as described herein. In one or more embodiments, wireless device 22 is configured to adapt (Block S148) the PDCCH monitoring for at least one cell 18 based on the at least one field value of the at least one bitfield, as described herein.

According to one or more embodiments, the wireless device 22 is configured with at least two search space set groups for the at least one cell 18 and where the search space set group switching corresponds to switching among the at least two search space set groups for the at least one cell 18. According to one or more embodiments, the wireless device 22 is configured with a skip duration for the at least one cell and where the skipping of PDCCH monitoring corresponds to skipping of PDCCH monitoring for the at least one cell 18 according to the skip duration. According to one or more embodiments, the at least one bitfield is configurable to take only field values that indicate to the wireless device 22 to perform search space set group switching, or take only field values that indicate to the wireless device 22 to perform skipping of PDCCH monitoring, or take field values that indicate to the wireless device 22 to perform search space set group switching as well as field values that indicate to the wireless device 22 to perform skipping of PDCCH monitoring.

According to one or more embodiments, the at least one bitfield is configured to take one or more of: at least two field values that indicate the search space set group switching, and one or more field values that indicate the skipping of PDCCH monitoring. According to one or more embodiments, the at least one field value includes one or more of: a first field value indicating to perform PDCCH monitoring according to a first search space set group, a second field value indicating to perform PDCCH monitoring according to a second search space set group, and a third field value indicating to skip PDCCH monitoring according to a skip duration. According to one or more embodiments, the at least one cell 18 includes a first serving cell 18 of the wireless device 22 and the at least one bitfield includes a bitfield for PDCCH monitoring adaptation for the first serving cell 18 and where the wireless device 22 is configured to receive the bitfield for PDCCH monitoring adaptation for the first serving cell 18 in the first serving cell 18.

According to one or more embodiments, the at least one cell 18 includes a group of cells 18 and the at least one bitfield includes a bitfield for PDCCH monitoring adaptation for the group of cells 18 and where the wireless device 22 is configured to receive the bitfield for PDCCH monitoring adaptation for the group of cells 18 in only a first cell of the group of cells 18. According to one or more embodiments, the first cell of the group of cells 18 is one of a primary cell and a secondary cell of the wireless device 22. According to one or more embodiments, the at least one cell includes a first group of cells 18 and a second group of cells 18 and where the at least one field value of the at least one bitfield includes a field value of a first bitfield associated with the first group of cells 18 and a field value of a second bitfield associated with the second group of cells 18 and where the wireless device 22 is configured to adapt PDCCH monitoring for the first group of cells 18 based on the field value of the first bitfield, and to adapt PDCCH monitoring for the second group of cells 18 based on the field value of the second bitfield.

According to one or more embodiments, the wireless device 22 is configured to receive the second bitfield for the PDCCH monitoring adaptation for the second group of cells 18 in at least one cell of the first group of cells 18 only. According to one or more embodiments, the at least one cell includes a second cell 18 that is not configured with a dormant bandwidth part, BWP, and where the at least one bitfield includes at least one secondary cell, SCell, dormancy bit that indicates to the wireless device 22 whether to perform one of search space set group switching and skipping of PDCCH monitoring for the second cell. According to one or more embodiments, the at least one bitfield is received in a downlink control information, DCI, format, and where the DCI format is one of DCI formats 0-1, 1-1, 1-2 and 0-2. According to one or more embodiments, the at least one bitfield is received in a downlink control information, DCI, format, where the at least one bitfield indicates whether to perform one of search space set group switching and skipping of PDCCH monitoring based on the DCI format being a first DCI format, and where the at least one bitfield only indicates whether to perform search space group switching or search space set group switching based on the DCI format being a second DCI format different from the first DCI format. According to one or more embodiments, the at least one bitfield is received in a downlink control information, DCI, format, and where the PDCCH monitoring adaptation depends on or is based on the DCI format.

Having generally described arrangements for modifying of PDCCH monitoring, details for these arrangements, functions and processes are provided as follows, and which may be implemented by the network node 16, wireless device 22 and/or host computer 24. One or more wireless device 22 functions described below may be performed/implemented by one or more of processing circuitry 84, processor 86, modification unit 34, radio interface 82, etc. One or more network node 16 functions described below may be performed/implemented by one or more of processing circuitry 68, processor 70, indication unit 32, radio interface 62, etc.

Some embodiments provide modifying of PDCCH monitoring. Arrangements for joint control of search space set group switching and PDCCH skipping are described in detail herein. In one or more embodiments, joint control may refer to where the at least one bitfield is configurable to take field values that indicate to the wireless device to perform search space set group switching and field values that indicate to the wireless device to perform skipping of PDCCH monitoring, but these field values do not indicate to the wireless device to simultaneously perform search space set group switching and skipping of PDCCH monitoring.

Note that when reference to DRX is made herein, this reference may include at least connected mode DRX (C-DRX). Such a DRX configuration typically includes an ON duration timer value, an inactivity timer value, and a long or short DRX cycle. In cases where short DRX cycle is configured, the configuration may additionally include a short DRX timer value.

A wireless device 22 is configured with DRX, and with at least one primary cell 18 that may be provided by network node 16. The wireless device 22 can be configured with one or more secondary cells 18 that may be provided by the network node 16 and/or another network node 16. Wireless device 22 can be configured with at least two search space set groups for at least one cell 18. Wireless device 22 can be further configured with a skip duration for the at least one cell 18. Wireless device 22 can be configured to monitor a downlink control information on at least one cell 18 containing at least a bitfield that can take field values indicating the wireless device 22 to monitor PDCCH according to a first search space set group (SSSG #0), or to monitor PDCCH according to a second search space set group (SSG #1), and to skip PDCCH monitoring for a duration indicated by the higher layers, or pre-configured, e.g., in standardization documentations such as in 3GPP. The bitfield can be referred to as PDCCH monitoring adaptation bitfield.

An example of the bitfield is shown in below in TABLE 1. The bitfield has 2 bits. The four resulting states can each indicate different wireless device 22 behavior regarding PDCCH monitoring adaptation. For example, the field value 01 can indicate that the wireless device start to monitor PDCCH according to search space sets in SSSG #0 (and stop PDCCH according to search space sets in SSSG #1). For example, the field value 10 can indicate that the wireless device 22 start to monitor PDCCH according to search space sets in SSSG #1 (and stop PDCCH according to search space sets in SSSG #0). For example, the field value 11 indicate for wireless device 22 to skip PDCCH monitoring for a time duration given by the skip duration. For example, the field value 00 can indicate “reserved”, for example to indicate that there is no change to wireless device 22's behavior with respect to PDCCH monitoring.

TABLE 1

| PDCCH Monitoring adaptation | |
|---|---|
| bit field value | WD behavior |
| 00 | No change or ‘reserved’ |
| 01 | Monitor SSSG#0 |
| 10 | Monitor SSSG#1 |
| 11 | Skip PDCCH monitoring |
| | for a skip duration |

In one or more embodiments, the downlink control information containing the bitfield (e.g., PDCCH monitoring adaptation bitfield) is received by wireless device 22 on a first serving cell 18, and the corresponding PDCCH monitoring adaptation is applicable for PDCCH monitoring on the first serving cell 18.

In one or more embodiments, the DCI bitfield is configured explicitly through higher layer signaling, e.g., RRC signaling, such as by network node 16. For example, the associated DCI may be a non-fallback scheduling DCI format 0-1, 1-1, 1-2, or 0-2. In one approach, wireless device 22 can be configured through RRC signaling such as by network node 16 with the PDCCH monitoring adaptation bitfield, and furthermore through RRC signaling, wireless device 22 can be configured if one or all the specific indications are configured. For example, the network node 16 may only configure PDCCH skipping and not SS switching on a first serving cell 18, and thus network node 16 only configures wireless device 22 with the bitfield associated with PDCCH skipping.

On the other hand, network node 16 may configure PDCCH skipping and SS switching on a second serving cell 18, and thus wireless device 22 is configured with all the indications mentioned in example above with respect to the configured bitfield. In another example, network node 16 can configure the PDCCH monitoring adaptation bitfield in the same manner for all the valid DCIs, or to configure the bitfield individually for each valid DCI. For example, network node 16 may configure the PDCCH monitoring adaptation bitfield in DCI formats 1-1 and 0-1, and not in DCI format 1-2 or 0-2, since these two DCIs may be used for latency sensitive application. Alternatively, network node 16 may configure all the fields in the adaptation bitfield for DCI formats 1-1 and 0-1, but may not configure PDCCH skipping for DCI formats 1-2 and 0-2, for example to avoid skipping PDCCH for latency sensitive applications.

In another embodiment, the wireless device 22 can be configured with the PDCCH monitoring adaption bitfield by pre-configuration or a combination of pre-configuration and higher layer signaling from network node 16. For example, if wireless device 22 receives a first configuration which meets a first condition, wireless device 22 may then configure the PDCCH monitoring adaptation bitfield, or if the first configuration meets a second condition, then wireless device 22 configures a subset of PDCCH monitoring bitfield and consider the rest as reserved or no change. In one example of this embodiment, wireless device 22 is configured such as by network node 16 with one or more search spaces (SSs) as the first configuration. In one approach, if any of the configured SSs is additionally configured as part of the first or second search space set groups (as the first condition), wireless device 22 may assume the PDCCH monitoring adaptation field is present in the DCIs associated to the SSs, or all the potential DCIs which can be used for SS switching/PDCCH skipping. In a subset realization of this approach, wireless device 22 can be further configured with the skip PDCCH monitoring indication field also or to consider it as reserved if received. In another example, the wireless device 22 may not be configured with search space set groups, but receives an indication from the higher layers configuring the PDCCH skipping indication in the PDCCH monitoring adaptation bitfield. In this case, wireless device 22 consider the search space set group switching bitfield either as reserved or no change.

In another embodiment, network node 16 may not transmit the PDCCH monitoring adaption bitfield even if configured. In this case, in one example, the wireless device 22 receives a first DCI containing the monitoring adaptation bitfield, and thus the wireless device 22 follows the indication in the DCI. Then, wireless device 22 receives a second DCI which could potentially include the bitfield as well, but wireless device 22 does not receive the bitfield. In this case, wireless device 22 behavior can be either configured by higher layer signaling from network node 16, or pre-configured such as by the network or network node 16. For example, if wireless device 22 does not receive the PDCCH monitoring adaptation bitfield in a second DCI, then wireless device 22 does not make any change, or wireless device 22 follows a configured behavior, e.g., falling back to the first search space set group.

When wireless device 22 is configured with carrier aggregation, the PDCCH monitoring adaptation can be further enhanced as described below.

Joint Indication with Carrier Aggregation (CA) and Grouping of Cells 18

Wireless device 22 can be configured with multiple serving cells 18 such as cells 18 belonging to frequency range 1 and/or frequency range 2 (FR1/FR2). The PDCCH monitoring adaptation can be configured such that a group of cells 18 can be controlled using a single field. For example, wireless device 22 can be configured with a first group of cells 18, and a second group of cells 18, and the PDCCH monitoring adaptation can be configured and controlled individually for each group of the two group of cells 18.

Wireless device 22 can be configured to monitor a downlink control information on at least one cell 18 containing at least a bitfield that can take field values indicating for wireless device 22 to monitor PDCCH according to a first search space set group on the first group of cells 18, and to monitor PDCCH according to a second search space set group on the first group of cells 18, and to skip PDCCH monitoring on the first group of cells 18 for a duration indicated by the higher layers. Wireless device 22 detects a downlink control information, determines whether to monitor PDCCH and determines the search spaces to monitor based on the detected DCI, and monitors downlink control channel accordingly, and receives a downlink message in the downlink control channel.

The DCI transmitted by, for example, network node 16, can contain at least a second bitfield that can take field values indicating for wireless device 22 to monitor PDCCH according to a first search space set group on the second group of cells 18, and to monitor PDCCH according to a second search space set group on the second group of cells 18, and to skip PDCCH monitoring on the second group of cells 18 for a duration indicated by the higher layers.

In certain embodiments, wireless device 22 can be configured with a first grouping of cells 18 for the search-space set group switching and a second grouping of cells 18 for the PDCCH skipping. For example, if wireless device 22 has/is configured with four cells 18 (c0,c1,c2,c3), then for search space set group switching, the first group can comprise c0, and the second group can comprise c1,c2,c3, while for PDCCH skipping, the first group can include c0, c1, and the second group can comprise c2, c3.

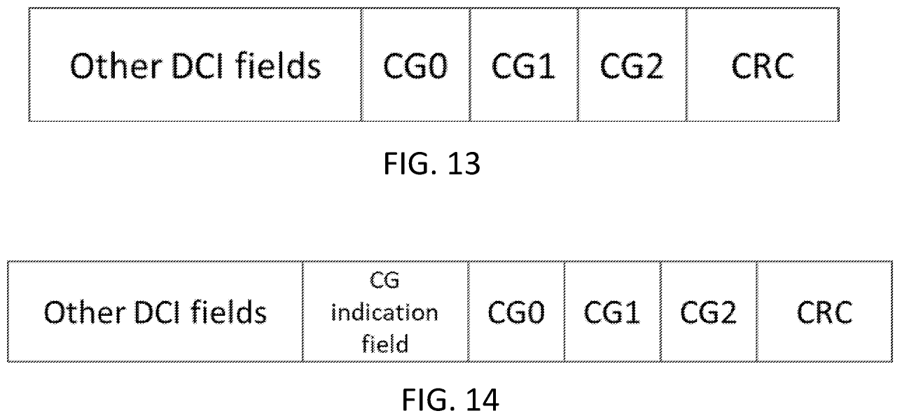

An example DCI format is shown in FIG. 13 where different bitfields are configured in a DCI to control PDCCH monitoring adaptation for different cells 18. FIG. 13 illustrates three different bitfields (CG0, CG1, CG2) to control search space set group switching and/or PDCCH skipping for three different groups of cells 18. Each field CG0 can control search space set group switching and/or PDCCH skipping for a group of cells 18 configured by higher layers. For example, if wireless device 22 is configured with FR1-FR2 carrier aggregation, a first cell group CG0 may contain the primary cell, a second cell group may contain the secondary serving cells 18 belonging to FR1, and a third cell group may contain the secondary serving cells 18 belonging to FR2.

Each field (e.g., CG0) corresponding to each group (first group of cells 18) can indicate four values for each group of cells 18, as shown in below in TABLE 2.

TABLE 2

| PDCCH Monitoring adaptation | |
|---|---|
| bit field value | WD behavior |
| 00 | No change or ‘reserved’ for the |
| | group of cells |
| 01 | Monitor SSSG#0 for the group of |
| | cells |
| 10 | Monitor SSSG#1 for the group of |
| | cells |
| 11 | Skip PDCCH monitoring for a skip |
| | duration for the group of cells |

For example, wireless device 22 can be configured with a first group of cells 18, and a second group of cells 18 associated with search space set group switching. Wireless device 22 can be configured with a third group of cells 18 to skip PDCCH monitoring. In an embodiment, the third group of cells 18 includes all serving cells 18 configured for wireless device 22. For example, the wireless device 22 can receive a configuration from higher layers that a first, a second and a third bitfields associated with a first, a second and a third group of cells 18 is configured, and further, the higher layer signaling can indicate the starting location of each bitfield or their length (in case the length of the bitfields are configurable or different). The first, second and third bitfields may each be considered a PDDCH monitoring adaptation bitfield or may be considered to be part of the overall PDCCH monitoring adaption bitfield.

In one embodiment, network node 16 is not required to transmit the associated bitfields all the time even if configured. For example, wireless device 22 may receive bitfield corresponding to CG0, but not CG1 and CG2. In this case, wireless device 22 either adopts a behavior which is configured through higher layer signaling, or a pre-configured, e.g., default behavior. The default behavior can be, for example, no change in behavior for the corresponding group of cells 18. For example, wireless device 22 may receive CG0, but not CG1 and CG2. As such, wireless device 22 implements the indication in CG0, but does not change the behavior in CG1 and CG2, otherwise wireless device 22 is configured differently from higher layers, e.g., to fall back to the first search space group.

In another embodiment, the presence or absence of the bitfields associated with the CGs can be indicated with another bitfield, e.g., a CG indication bitfield. An example illustration is illustrated in FIG. 14 where different bitfields configured in a DCI to control PDCCH monitoring adaptation for different cell groups as well as a CG indication bitfield to activate or deactivate a specific CG PDCCH monitoring adaption bitfield are illustrated.

Wireless device 22 may be configured to monitor three bits given by CG indication bitfield, corresponding to CG0, CG1 and CG2. Each bit in the indication bitfield can indicate to wireless device 22 which of the CG PDCCH monitoring adaption bitfields are transmitted. For example, wireless device 22 may receive CG indication bitfield set to 100 indicating that only information about CG0 is transmitted but not CG1 and CG2, or 110 indicating information about CG0 and CG1 are transmitted but not CG2, or 001 indicating information about only CG2 is transmitted and so on. The advantage of this approach is to reduce the number of transmitted bits if network node 16 does not want to change the PDCCH monitoring in a specific CG.

Wireless device 22 can be configured to monitor a downlink control information on at least one cell 18 containing at least a bitfield that can take field values indicating wireless device 22 to skip PDCCH monitoring according to a first skip duration on a first group of cells 18, and, to skip PDCCH monitoring according to a second skip duration on a second group of cells 18, where the grouping of cells 18 is configured by higher layers. The first and second skip durations are also configured by higher layers. Wireless device 22 detects a downlink control information, determines a PDCCH skip duration based on the detected DCI, skips PDCCH decoding on the corresponding group of cells 18, monitors downlink control channel accordingly after the skip duration, and receive a downlink message in the downlink control channel.

In certain embodiments, only the special cell 18 (e.g., primary cell 18 in the MCG or the primary cell 18 in SCG) can be configured to carry the PDCCH monitoring adaptation bitfield for the different groups of cells 18, or alternatively, the bitfield can be present in the DCI scheduling the primary cell 18 only. In yet another embodiment, the PDCCH monitoring adaptation bitfield carried in a scheduling DCI for a secondary serving cell 18 can adapt PDCCH monitoring for the secondary serving cell 18 only.

In some embodiments, the PDCCH monitoring adaptation bitfield corresponds to the bitfield that jointly indicates search space set group switching and PDCCH skipping. In some embodiments, the PDCCH monitoring adaptation bitfield corresponds to the bitfield that can indicate at least one of search space set group switching and PDCCH skipping.

In some embodiments, a cell x (e.g., primary cell 18 in the MCG or the primary cell 18 in SCG) can be configured to adapt PDCCH monitoring for a group of cells 18 (e.g., carry the PDCCH monitoring adaptation bitfield for the different group of cells 18), or for a single cell (e.g., same as cell 18), and the downlink control information includes an indication to indicate whether the bitfield adapts PDCCH monitoring for a group of cells 18 or itself.

Note that embodiments described herein are applicable to cases that wireless device 22 is not configured with cross-carrier scheduling for one or more secondary cells 18, as well as the ones that wireless device 22 is configured with cross-carrier scheduling for one or more secondary cells 18. For example, wireless device 22 may be configured with a first secondary cell 18 and a second secondary cell 18, where the first secondary cell 18 is additionally configured to be scheduled from the primary cell 18. Furthermore, wireless device 22 is configured with PDCCH monitoring adaptation of all the secondary cells 18 from the primary cell 18. In this case, in one example, wireless device 22 can be configured with PDCCH monitoring adaption bitfields in all the associated scheduling DCIs received in the primary cell 18 for all the cells 18. In another example, the first secondary cell 18 PDCCH monitoring adaption is only configured to be handled through the DCIs received in primary cell 18 to schedule the secondary cells 18, and the PDCCH monitoring adaptation of primary cell 18 and the second secondary cell 18 are handled through scheduling DCIs intended for the primary cell 18.

Interaction with SCell Dormancy

In certain embodiments, wireless device 22 may be configured such as by, for example, network node 16, with an explicit higher layer parameter indicating to use the dormancy framework to enable PDCCH monitoring adaptation according search space set group switching. For example, wireless device 22 can be configured such as by network node 16 with at least some serving cells 18 that are not configured with a dormant BWP (e.g., FRI secondary serving cells 18), and some serving cells 18 that are configured with a dormant BWP (e.g., FR2 secondary serving cells 18). Wireless device 22 can be configured to use SCell dormancy bitfields, where for a first group of cells 18 for which there is no dormant BWP, the SCell dormancy bit can be reinterpreted as indicating to monitor PDCCH according to a first search space set group on the first group of cells 18, or to monitor PDCCH according to a second search space set group on the first group of cells 18. Wireless device 22 can be configured to use SCell dormancy bitfields, where for a first group of cells 18 for which there is no dormant BWP, the SCell dormancy bit can be reinterpreted as indicating to skip PDCCH monitoring for a first skip duration on the first group of cells 18.

When wireless device 22 is explicitly configured with scheduling DCI based format search space group switching functionality, wireless device 22 does not apply any search space set group switching based on DCI 2_0. Wireless device 22 may still be configured with a timer value, that allows wireless device 22 to switch between the first search space group and the second search space group.

Note that some embodiments described herein focus on including the PDCCH monitoring adaption through scheduling DCIs. Nevertheless, the same methods and mechanisms can be readily applied when PDCCH monitoring adaption is handled through non-scheduling DCIs, e.g., DCI format 2-6 or DCI format 1-1 that does not schedule PDSCH.

In some cases, wireless device 22 may be configured for SSSG switching only on the primary cell 18 or sPCell 18.

In one embodiment, wireless device 22 is configured with multiple serving cells 18 (e.g., c0, c1,c2). For some or all of the multiple serving cells 18, wireless device 22 is configured with multiple search space groups (SSGs). For example, for each cell 18, wireless device 22 may be configured with a SSSG0 with SS sets having frequent PDCCH monitoring (e.g., PDCCH monitored every slot) and a SSSG1 with SS sets having sparse PDCCH monitoring (e.g., PDCCH monitored every N slots, N configured by higher layers with values e.g., 4, 8, 20 etc.). On a first serving cell 18 of the multiple serving cells 18, wireless device 22 may detect a first DCI indicating whether to monitor PDCCH for the first serving cell 18 according a first SSG or a second SSG of the multiple SSGs. For example, wireless device 22 may on cell c1 detect the first DCI in slot x indicating it to monitor PDCCH according to SSG1 and in response start monitoring PDCCH on c1 according SSG1 (e.g., once every N slots) in slots later than slot x. On a second serving cell 18 of the multiple serving cells 18 (e.g., c0), wireless device 22 may detect a second DCI indicating whether to monitor PDCCH for the first serving cell 18 according the first SSG or the second SSG of the multiple SSGs. For example, wireless device 22 may on cell c0 detect the second DCI in slot y indicating it to monitor PDCCH in cell c1 according to SSG0, and in response start monitoring PDCCH on c1 according SSG0 (e.g., once every slot) in slots of c1 later than slot y. With this framework, PDCCH monitoring on a first serving cell 18 can be adapted from frequent to sparse using DCI on the same first serving cell 18, but when required, DCI on another second cell 18 (with frequent PDCCH monitoring) can be used to switch the PDCCH monitoring from sparse to frequent. Such operation reduces the latency for data scheduling by making the first serving cell 18 available sooner without waiting for PDCCH opportunities provided by sparse PDCCH monitoring SSG. In some cases, the second serving cell 18 that indicates SSG switch for first serving cell 18 can be the sPCell 18. In some other cases, the second serving cell 18 can be configured via RRC. In cases where wireless device 22 receives first DCI and second DCI in slots that overlap in time, wireless device 22 may follow an indication in one of the DCIs according to a priority rule (e.g., DCI on sPCell 18 is always prioritized, DCI on first cell 18 (i.e., same cell 18) is prioritized, DCI on second cell 18 (i.e., different cell 18) is prioritized.

Therefore, in one or more embodiments, one or more methods using a single bitfield to enable both search space set group switching and PDCCH skipping are provided. The bitfield may be configured by network node 16. Further, one or more methods of simultaneously using cells 18 groups-based PDCCH monitoring adaptation indication on primary cell 18 and individual cell-based PDCCH monitoring adaptation on respective secondary cells 18 are provided.

### SOME EXAMPLES

Example A1. A network node 16 configured to communicate with a wireless device 22 (WD 2), the network node 16 configured to, and/or comprising a radio interface 62 and/or comprising processing circuitry 68 configured to:
configure an indication for modifying physical downlink control channel, PDCCH, monitoring using at least one of search space set group switching and PDCCH skipping; and
cause transmission of the indication to the wireless device 22.
Example A2. The network node 16 of Example A1, wherein the indication is a bitfield that indicates performing both the search space set group switching and PDCCH skipping.
Example A3. The network node 16 of any one of Examples A1-A2, wherein the bitfield is configured to control at least one of search space set group switching and PDCCH skipping for at least one group of cells 18.
Example A4. The network node 16 of Example A3, wherein the bitfield is configured to control at least one of search space set group switching and PDCCH skipping for a first group of cells 18 and separately for a second group of cells 18.
Example A5. The network node 16 of any one of Examples A1-A4, wherein the bitfield is one of a PDCCH monitoring adaptation bitfield and cell group indication bitfield.
Example B1. A method implemented by a network node 16 that is configured to communicate with a wireless device 22, the method comprising:
configuring an indication for modifying physical downlink control channel,
PDCCH, monitoring using at least one of search space set group switching and PDCCH skipping; and causing transmission of the indication to the wireless device 22.
Example B2. The method of Example B1, wherein the indication is a bitfield that indicates performing both the search space set group switching and PDCCH skipping.
Example B3. The method of any one of Examples B1-B2, wherein the bitfield is configured to control at least one of search space set group switching and PDCCH skipping for at least one group of cells 18.
Example B4. The method of Example B3, wherein the bitfield is configured to control at least one of search space set group switching and PDCCH skipping for a first group of cells 18 and separately for a second group of cells 18.
Example B5. The method of any one of Examples B1-B4, wherein the bitfield is one of a PDCCH monitoring adaptation bitfield and cell group indication bitfield.
Example C1. A wireless device 22 (WD 22) configured to communicate with a network node 16, the WD 22 configured to, and/or comprising a radio interface 82 and/or processing circuitry 84 configured to:
receive an indication for modifying physical downlink control channel, PDCCH, monitoring using at least one of search space set group switching and PDCCH skipping; and
modify the PDCCH monitoring based on the indication.
Example C2. The WD 22 of Example C1, wherein the indication is a bitfield that indicates performing both the search space set group switching and PDCCH skipping.
Example C3. The WD 22 of any one of Examples C1-C2, wherein the bitfield is configured to control at least one of search space set group switching and PDCCH skipping for at least one group of cells 18.
Example C4. The WD 22 of Example C3, wherein the bitfield is configured to control at least one of search space set group switching and PDCCH skipping for a first group of cells 18 and separately for a second group of cells 18.
Example C5. The WD 22 of any one of Examples C1-C4, wherein the bitfield is one of a PDCCH monitoring adaptation bitfield and cell group indication bitfield.
Example D1. A method implemented in a wireless device 22 (WD 22) that is configured to communicate with a network node 16, the method comprising: receiving an indication for modifying physical downlink control channel, PDCCH, monitoring using at least one of search space set group switching and PDCCH skipping; and modifying the PDCCH monitoring based on the indication.
Example D2. The method of Example D1, wherein the indication is a bitfield that indicates performing both the search space set group switching and PDCCH skipping.
Example D3. The method of any one of Examples D1-D2, wherein the bitfield is configured to control at least one of search space set group switching and PDCCH skipping for at least one group of cells 18.
Example D4. The method of Example D3, wherein the bitfield is configured to control at least one of search space set group switching and PDCCH skipping for a first group of cells 18 and separately for a second group of cells 18.
Example D5. The method of any one of Examples D1-D4, wherein the bitfield is one of a PDCCH monitoring adaptation bitfield and cell group indication bitfield.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
5G-S-TMSI Serving Temporary Mobile Subscriber Identity
ACK Acknowledgment
ACK/NACK Acknowledgment/Not-acknowledgment
BWP Bandwidth Part
CBG Code Block Group
CSI-RS Channel State Information Reference Signal
DCI Downlink Control Information
DRX Discontinuous Reception
HARQ Hybrid Automatic Repeat Request
I-RNTI Inactive Radio Network Temporary Identifier
MCS Modulation and Coding Scheme
MIMO Multiple Input Multiple Output
NACK Not-acknowledgment
PDCCH Physical Downlink Control Channel
PDSCH Physical Downlink Shared Channel
PO Paging Occasion
PPM Parts Per Million
PRB Physical Resource Block
PUCCH Physical Uplink Control Channel
SE Spectral efficiency
SSB Synchronization Signal Block
SNR Signal to Noise Ratio
TB Transport Block
TRS Tracking Reference Signal
UCI Uplink Control Information

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device configured to communicate with a network node, the wireless device configured to:
receive at least one bitfield for physical downlink control channel, PDCCH, monitoring adaptation, the at least one bitfield being configured to take at least one field value to indicate to the wireless device to perform one of:
search space set group switching; and
skipping of PDCCH monitoring;
adapt the PDCCH monitoring for at least one cell based on the at least one field value of the at least one bitfield;
the wireless device being configured with at least two search space set groups for the at least one cell and the search space set group switching corresponding to switching among the at least two search space set groups for the at least one cell; and
the at least one bitfield is received in one of downlink control information, DCI, formats 0-1, 1-1, 1-2 and 0-2.

2. (canceled)

3. The wireless device of claim 1, wherein the wireless device is configured with a skip duration for the at least one cell and wherein the skipping of PDCCH monitoring corresponds to skipping of PDCCH monitoring for the at least one cell according to the skip duration.

4. (canceled)

5. The wireless device of claim 1, wherein the at least one bitfield is configured to take one or more of:
at least two field values that indicate the search space set group switching; and
one or more field values that indicate the skipping of PDCCH monitoring.

6. The wireless device of claim 1, wherein the at least one field value includes one or more of:
a first field value indicating to perform PDCCH monitoring according to a first search space set group;
a second field value indicating to perform PDCCH monitoring according to a second search space set group; and
a third field value indicating to skip PDCCH monitoring according to a skip duration.

7. The wireless device of claim 1, wherein the at least one cell includes a first serving cell of the wireless device and the at least one bitfield includes a bitfield for PDCCH monitoring adaptation for the first serving cell and wherein the wireless device is configured to receive the bitfield for PDCCH monitoring adaptation for the first serving cell in the first serving cell.

8.-13. (canceled)

14. A network node configured to communicate with a wireless device, the network node configured to:
configure the wireless device with at least one bitfield for physical downlink control channel, PDCCH, monitoring adaptation, the at least one bitfield being configured to take at least one field value to indicate to the wireless device to perform one of:
search space set group switching; and
skipping of PDCCH monitoring; and
cause transmission of the at least one bitfield to the wireless device to adapt the PDCCH monitoring for at least one cell at the wireless device based on the at least one field value of the at least one bitfield, the at least one bitfield being transmitted in one of downlink control information, DCI, formats 0-1, 1-1, 1-2 and 0-2;
configure the wireless device with at least two search space set groups for the at least one cell, wherein the search space set group switching corresponds to switching among the at least two search space set groups for the at least one cell;
configure the wireless device with at least two search space set groups for the at least one cell, the search space set group switching corresponding to switching among the at least two search space set groups for the at least one cell.

15. (canceled)

16. The network node of claim 14, wherein the network node is further configured to configure the wireless device with a skip duration for the at least one cell, wherein the skipping of PDCCH monitoring corresponds to skipping of PDCCH monitoring for the at least one cell according to the skip duration.

17. (canceled)

18. The network node of claim 14, wherein the at least one bitfield is configured to take one or more of:
at least two field values that indicate the search space set group switching; and
one or more field values that indicate the skipping of PDCCH monitoring.

19. The network node of claim 14, wherein the at least one field value includes one or more of:
a first field value indicating to perform PDCCH monitoring according to a first search space set group;
a second field value indicating to perform PDCCH monitoring according to a second search space set group; and
a third field value indicating to skip PDCCH monitoring according to a skip duration.

20. The network node of claim 14, wherein the at least one cell includes a first serving cell of the wireless device and the at least one bitfield includes a bitfield for PDCCH monitoring adaptation for the first serving cell and wherein the network node being configured to cause the transmission to the wireless device comprises the network node being configured to cause transmission of the bitfield for PDCCH monitoring adaptation for the first serving cell to the wireless device in the first serving cell.

21.-26. (canceled)

27. A method implemented by a wireless device that is configured to communicate with a network node, the method comprising:
receiving at least one bitfield for physical downlink control channel, PDCCH, monitoring adaptation, the at least one bitfield being configured to take at least one field value to indicate to the wireless device to perform one of:
search space set group switching; and
skipping of PDCCH monitoring;
adapting the PDCCH monitoring for at least one cell based on the at least one field value of the at least one bitfield;
the wireless device being configured with at least two search space set groups for the at least one cell and wherein the search space set group switching corresponds to switching among the at least two search space set groups for the at least one cell; and
the at least one bitfield is received in one of downlink control information, DCI, formats 0-1, 1-1, 1-2 and 0-2.

28. (canceled)

29. The method of claim 27, wherein the wireless device is configured with a skip duration for the at least one cell and wherein the skipping of PDCCH monitoring corresponds to skipping of PDCCH monitoring for the at least one cell according to the skip duration.

30. (canceled)

31. The method of claim 27, wherein the at least one bitfield is configured to take one or more of:
at least two field values that indicate the search space set group switching; and
one or more field values that indicate the skipping of PDCCH monitoring.

32. The method of claim 27, wherein the at least one field value includes one or more of:
a first field value indicating to perform PDCCH monitoring according to a first search space set group;
a second field value indicating to perform PDCCH monitoring according to a second search space set group; and
a third field value indicating to skip PDCCH monitoring according to a skip duration.

33. The method of claim 27, wherein
the at least one cell includes a first serving cell of the wireless device and the at least one bitfield includes a bitfield for PDCCH monitoring adaptation for the first serving cell and wherein the wireless device receives the bitfield for PDCCH monitoring adaptation for the first serving cell in the first serving cell.

34.-39. (canceled)

40. A method implemented by a network node that is configured to communicate with a wireless device, the method comprising:
configuring the wireless device with at least two search space set groups for at least one cell;
configuring the wireless device with at least one bitfield for physical downlink control channel, PDCCH, monitoring adaptation, the at least one bitfield being configured to take at least one field value to indicate to the wireless device to perform one of:
search space set group switching; and
skipping of PDCCH monitoring;
causing transmission of the at least one bitfield to the wireless device to adapt the PDCCH monitoring for the at least one cell at the wireless device based on the at least one field value of the at least one bitfield, the at least one bitfield is transmitted in one of downlink control information, DCI, formats 0-1, 1-1, 1-2 and 0-2; and
the search space set group switching corresponding to switching among the at least two search space set groups for the at least one cell.

41. (canceled)

42. The method of claim 40, further comprising configuring the wireless device with a skip duration for the at least one cell, wherein the skipping of PDCCH monitoring corresponds to skipping of PDCCH monitoring for the at least one cell according to the skip duration.

43. (canceled)

44. The method of claim 40, wherein the at least one bitfield is configured to take one or more of:
at least two field values that indicate the search space set group switching; and
one or more field values that indicate the skipping of PDCCH monitoring.

45. The method of claim 40, wherein the at least one field value includes one or more of:
a first field value indicating to perform PDCCH monitoring according to a first search space set group;
a second field value indicating to perform PDCCH monitoring according to a second search space set group; and
a third field value indicating to skip PDCCH monitoring according to a skip duration.

46. The method of claim 40, wherein the at least one cell includes a first serving cell of the wireless device and the at least one bitfield includes a bitfield for PDCCH monitoring adaptation for the first serving cell and wherein the network node causing the transmission to the wireless device comprises the network node causing transmission of the bitfield for PDCCH monitoring adaptation for the first serving cell to the wireless device in the first serving cell.

47.-52. (canceled)
